(19) United States
(12) Patent Application Publication
(10) Pub. No.: US 2007/0200507 A1
(43) Pub. Date: Aug. 30, 2007

(54) DEVICE FOR DRIVING LIGHT SOURCE MODULE

(75) Inventors: TIEN-HSIANG MENG, Shenzhen (CN); CHI-HSIUNG LEE, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,720

(22) Filed: Sep. 15, 2006

(30) Foreign Application Priority Data
Feb. 24, 2006 (TW) 95106276

(51) Int. Cl. B60Q 1/02

(52) U.S. Cl. 315/82

(57) ABSTRACT

A driving device for driving a light source module (34) includes a power stage circuit (31), a transformer and resonance circuit (32), a current balancing circuit (33), a voltage sensing circuit (35) and a PWM controller (37). The power stage circuit converts a received direct current (DC) signal to an alternating current (AC) signal. The transformer and resonance circuit converts the AC signal to an appropriate signal to drive the light source module. The current balancing circuit is connected between the transformer and resonance circuit and the light source module, for balancing current flowing through the light source module. The voltage sensing circuit is connected to the transformer and resonance circuit, for sensing a voltage level of the appropriate signal provided to the light source module. The PWM controller is connected between the voltage sensing circuit and the power stage circuit, for controlling output thereof according to the sensed voltage level.

### 1. FIELD OF THE INVENTION

The invention relates to electronic driving devices, and particularly to a driving device for driving a light source module such as one containing discharge lamps of a liquid crystal display (LCD) panel.

### 2. DESCRIPTION OF RELATED ART

Conventionally, discharge lamps such as cold cathode fluorescent lights (CCFLs) have been used as light sources for liquid crystal display (LCD) panels, and must be driven by high voltages. In order to ensure normal operation of the discharge lamps, there is a need to monitor and control voltage provided to the discharge lamps.

FIG. 4 is a conventional driving device for driving a light source module 14. A power stage circuit 11 receives a direct current (DC) signal from a DC power source 10, and converts the DC signal to an alternating current (AC) signal. A transformer and resonance circuit 12 converts the AC signal to an appropriate signal to drive the light source module 14. A current balancing circuit 13 is connected between the transformer and resonance circuit 12 and a high voltage terminal of the light source module 14. A voltage sensing circuit 15 is connected to low voltage terminals of the light source module 14, and senses a voltage level of the signal provided to the light source module 14, and transmits the sensed voltage level to the PWM controller 16. The PWM controller 16 determines whether the light source module 16 is operating normally according to the sensed voltage level, and controls output thereof.

FIG. 5 is another conventional driving device for driving a light source module 24. The driving device is substantially the same as that of FIG. 4, except that a voltage sensing circuit 25 is connected to a transformer and resonance circuit 22, that is, it is connected to a low voltage terminal of the secondary winding of the transformer T, for sensing a voltage level of the signals provided to the light source module 24, and the sensed voltage levels are transmitted to a PWM controller 26.

In the conventional driving device in FIG. 4, the light source module 14 has external low voltage terminals, so that the voltage level can be sensed from the low voltage terminals connected to the voltage sensing circuit 15. However, light source modules currently available in the market or on sale do not really have external low voltage terminals, as an example as the light source module 25 shown in FIG. 5, because the low voltage terminals of lamps are normally connected together and integrated inside the currently available light source module. Therefore, the sensed voltage level received from the low voltage terminals is not suitable to designs of the light source module.

Therefore, the voltage level is sensed from the low voltage terminal of the secondary winding of the transformer connected to the voltage sensing circuit 25 as shown in FIG. 5. However, current flowing through the light source module 24 is also fed back from the low voltage terminal of the secondary winding of the transformer T. Accordingly, the current signal and the sensed voltage level significantly affect each other. Thus it requires a complex circuit design to reduce the signal affection.

### SUMMARY OF THE INVENTION

An exemplary embodiment of the invention provides a driving device for driving a light source module. A driving device includes a power stage circuit, a transformer and resonance circuit, a current balancing circuit, a voltage sensing circuit and a PWM controller. The power stage circuit converts a received direct current (DC) signal to an alternating current (AC) signal. The transformer and resonance circuit converts the AC signal to an appropriate signal to drive the light source module. The current balancing circuit is connected between the transformer and resonance circuit and the light source module, for balancing current flowing through the light source module. The voltage sensing circuit is connected to the transformer and resonance circuit, for sensing a voltage level of the signal provided to the light source module. The PWM controller is connected between the voltage sensing circuit and the power stage circuit, for controlling output thereof according to the sensed voltage level.

Other advantages and novel features will become more apparent from the following detailed description of preferred embodiments when taken in conjunction with the accompanying drawings, in which:

### BRIEF DESCRIPTION OF THE DRAWINGS

FIG. 1 is a driving device of an exemplary embodiment of the present invention;

FIG. 2 is a driving device of another exemplary embodiment of the present invention;

FIG. 3 is a driving device of a yet another exemplary embodiment of the present invention;

FIG. 4 is a conventional driving device; and

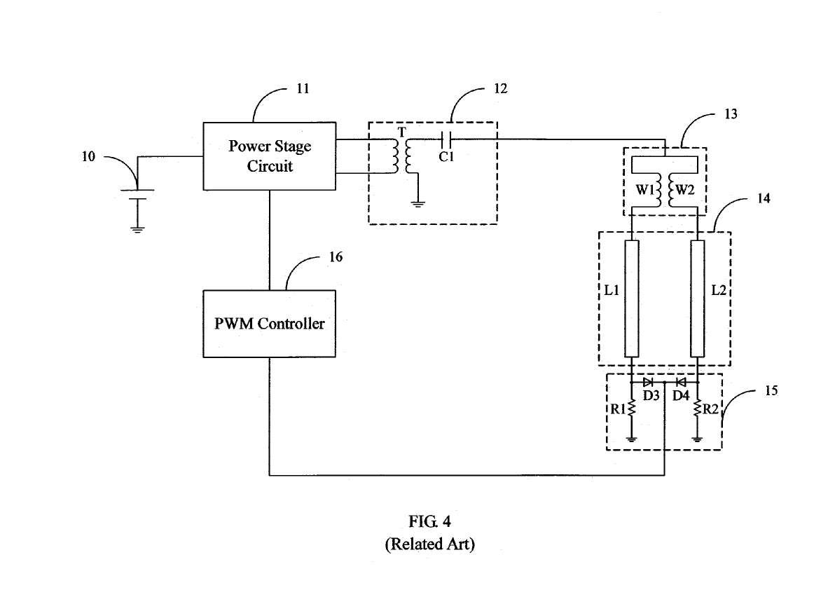

FIG. 5 is another conventional driving device.

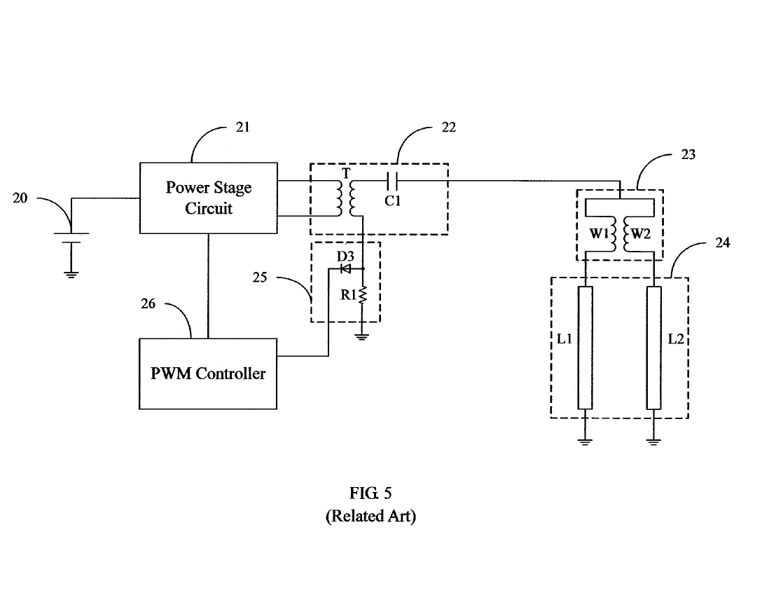

### DETAILED DESCRIPTION OF THE INVENTION

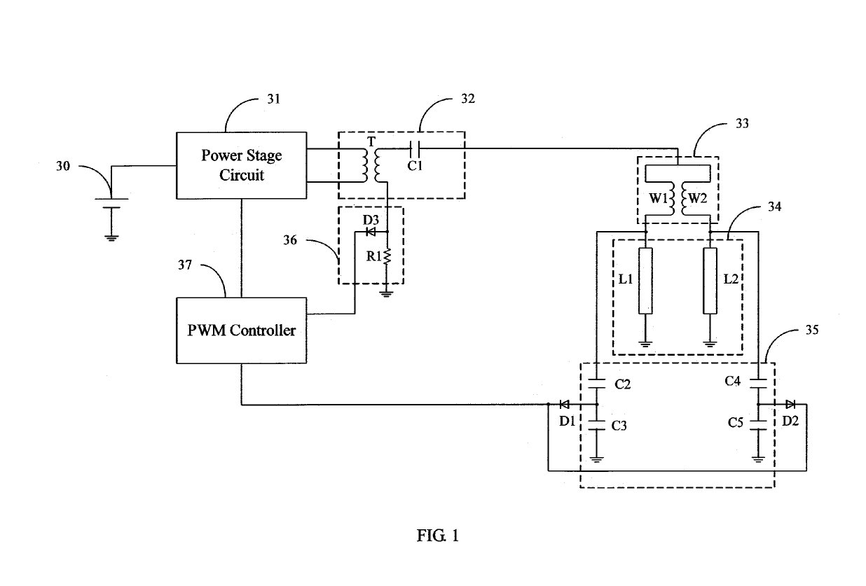

FIG. 1 is driving device of a first exemplary embodiment of the present invention. The driving device for driving a light source module 34 includes a direct current (DC) power source 30, a power stage circuit 31, a transformer and resonance circuit 32, a current balancing circuit 33, a voltage sensing circuit 35, a feedback circuit 36, and a PWM controller 37. In the exemplary embodiment, the light source module 34 includes a plurality of lamps L1 and L2.

The power stage circuit 31 converts a DC power signal received from the DC power source 30 to an alternating current (AC) signal. The transformer and resonance circuit 32 is connected to the power stage circuit 31, and converts the AC signal to an appropriate signal to drive the light source module 34. In the exemplary embodiment, the AC signal output from the power stage circuit 31 is a square-wave signal, and the appropriate signal output from the transformer and resonance circuit 32 to drive the light source module 34 is a sine-wave signal.

The transformer and resonance circuit 32 includes a transformer T and capacitor C1. The transformer T has a primary winding and a secondary winding, and the primary winding is connected to the power stage circuit 31. The capacitor C1 is connected between a high voltage terminal of the secondary winding of the transformer T and the current balancing circuit 33, which has a resonance function with an leakage inductance of the transformer T.

In the exemplary embodiment, the current balancing circuit 33 includes a common-mode choke including two coils W1 and W2. One end of each of the coils W1 and W2 are respectively connected to the lamps L1 and L2, and the other ends thereof are common connected to the high voltage terminal of the secondary winding of the transformer T, for balancing current flowing through the light source module 34.

The voltage sensing circuit 35 is connected to the coils W1, W2 of the current balancing circuit 33, and senses a voltage level of the signal provided to the light source module 34. That is, the voltage sensing circuit 35 is connected to high voltage terminals of the lamps L1 and L2, which are the terminals of the lamps L1 and L2 connected to the current balancing circuit 33.

The voltage sensing circuit 35 includes a plurality of voltage divider components. In the exemplary embodiment, the voltage divider components comprise capacitors with appropriate voltage tolerance, such as capacitors C2, C3, C4, and C5. In alternative embodiments, the voltage divider components can be other components with similar voltage tolerance characteristics.

The capacitors C2 and C3 are connected in series between the coil W1 of the current balancing circuit 33 and the ground, for dividing the appropriate signal from the lamp L1. The capacitors C4 and C5 are also connected in series between the coil W2 and the ground, for dividing the appropriate signal from the lamp L2.

Similarly, the driving device includes two diodes D1 and D2. An anode of the diode D1 is connected to a node of the capacitors C2 and C3, and a cathode of the diode D1 is connected to the PWM controller 37, for sensing the voltage level of the divided signal of the capacitors C2 and C3. An anode of the diode D2 is connected to a node of the capacitors C4 and C5, a cathode of the diode D2 is connected to the PWM controller 37, for sensing the voltage level of the divided signal of the capacitors C4 and C5.

In the exemplary embodiment, the appropriate signal provided to the light source module 34 is an AC signal having positive and negative duty cycles in turns, and the voltage level sensed from the voltage sensing circuit 35 and output to the PWM controller 37 via the diodes D1 and D2 is a positive peak value thereof.

The PWM controller 37 compares the sensed voltage level with a predetermined range. If the sensed voltage level is not in the predetermined range, the light source module 34 is abnormal, and the PWM controller 37 cuts off output thereof in order to prevent the lamps L1 and L2 from breaking down. For example, if the lamps L1 and L2 have an open circuit, the sensed voltage level is relatively large and is greater than the predetermined range, the PWM controller 37 immediately cuts off output thereof.

The feedback circuit 36 is connected between a low voltage terminal of the secondary winding of the transformer T and the PWM controller 37, for providing a feedback signal of the current flowing through the light source module 34. The feedback circuit 36 includes a diode D3 and a resistor R1. The resistor R1 is connected between the low voltage terminal of the secondary winding of the transformer T and the ground. An anode of the diode D3 is connected to the low voltage terminal of the secondary winding of the transformer T, and a cathode of the diode D3 is connected to the PWM controller 37. In the exemplary embodiment, the resistor R1 and the diode D3 provide a voltage signal to the PWM controller 37, which indicates the current flowing through the light source module 34.

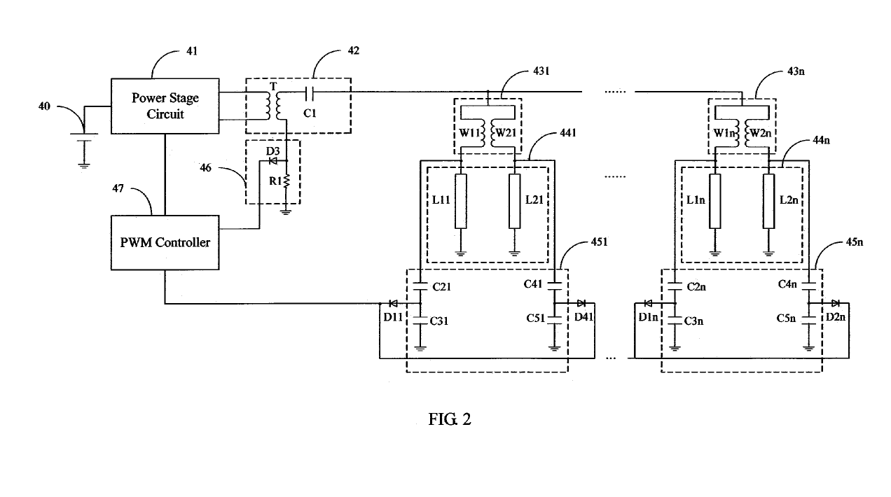

FIG. 2 is a driving device of another exemplary embodiment of the present invention. The driving device of FIG. 2 is substantially the same as that of FIG. 1, except that the driving device of FIG. 2 for driving a plurality of light source modules 44n (n=1, 2, 3, . . . , n) includes a plurality of current balancing circuits 43n (n=1, 2, 3, . . . , n) and voltage sensing circuits 45 (n=1, 2, 3, . . . , n). The current balancing circuits 43n (n=1, 2, 3, . . . , n) are respectively connected to a high voltage terminal of the secondary winding of the transformer T and high voltage terminals of corresponding lamps of the light source module 44n (n=1, 2, 3, . . . , n).

Structure of the current balancing circuits 43n (n=1, 2, 3, . . . , n), the voltage sensing circuits 45n (n=1, 2, 3, . . . , n) and the light source modules 44n (n=1, 2, 3, . . . , n) are substantially the same as those of the current balancing circuit 33, the voltage sensing circuit 35, and the light source module 44 of FIG. 1. Connections between the current balancing circuits 43n (n=1, 2, 3, . . . , n) and the light source modules 44n (n=1, 2, 3, . . . , n) are substantially the same as those of the current balancing circuit 33 and light source module 34 of FIG. 1. Therefore, description is omitted.

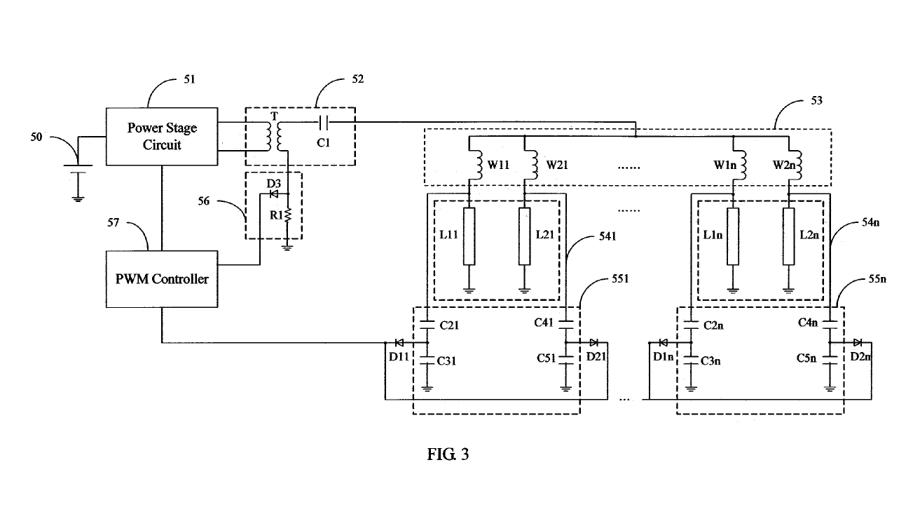

FIG. 3 is a driving device of yet another exemplary embodiment of the present invention. The driving device of FIG. 3 is substantially the same as that of FIG. 2, except that the driving device of FIG. 3 includes a current balancing circuit 53 including a plurality of coils W1n (n=1, 2, 3, . . . , n) and W2n (n=1, 2, 3, . . . , n). The coils W1n (n=1, 2, 3, . . . , n) and W2n (n=1, 2, 3, . . . , n) are in parallel and are respectively connected between a high voltage terminal of the secondary winding of the transformer T and corresponding lamps L1n (n=1, 2, 3, . . . , n) and L2n (n=1, 2, 3, . . . , n), for balancing current flowing through the light source modules 54n (n=1, 2, 3, . . . , n).

In the present invention, a sensed voltage level is received from a high voltage terminal of the secondary winding of a transformer, which is not affected by a configuration of the low voltage terminals of lamps of a light source module. In addition, the sensed voltage signal and a feedback current signal are separate from each other, and thus, they do not interfere with each other allowing a simple circuit structure.

While embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A driving device for driving a light source module comprising a plurality of lamps, comprising:
a power stage circuit for converting a received direct current (DC) signal to an alternating current (AC) signal;
a transformer and resonance circuit connected to the power stage circuit, for converting the AC signal to another signal to drive the light source module;
a current balancing circuit connected between the transformer and resonance circuit and the light source module, for balancing current flowing through the light source module;
a voltage sensing circuit connected to the current balancing circuit, for sensing a voltage level of the signal provided to the light source module; and
a pulse width modulation (PWM) controller connected between the voltage sensing circuit and the power stage circuit, for controlling output thereof according to the sensed voltage level.

2. The driving device as claimed in claim 1, further comprising a DC power source for providing the DC power signal.

3. The driving device as claimed in claim 1, wherein the current balancing circuit comprises a common-mode choke having a first coil and a second coil respectively connected between the transformer and resonance circuit and corresponding lamps of the light source module.

4. The driving device as claimed in claim 3, wherein the voltage sensing circuit comprises:
a first voltage divider component;
a second voltage divider component connected in series with the first voltage divider component;
a third voltage divider component; and
a fourth voltage divider component connected in series with the third voltage divider component;
wherein the first and second voltage divider components are connected between the first coil of the current balancing circuit and the ground, and the third and fourth voltage divider components are connected between the second coil of the current balancing circuit and the ground.

5. The driving device as claimed in claim 4, wherein the first, second, third, and fourth voltage divider components comprise capacitors.

6. The driving device as claimed in claim 1, further comprising a feedback circuit connected between the transformer and resonance circuit and the PWM controller, for providing a feedback signal of the current flowing through the light source module.

7. A driving device for driving a plurality of light source modules comprising a plurality of lamps, comprising:
a power stage circuit for converting a received direct current (DC) signal to an alternating current (AC) signal;
a transformer and resonance circuit connected to the power stage circuit, for converting the AC signal to another signal to drive the light source module;
a plurality of current balancing circuits, connected between the transformer and resonance circuit and the light source module, for balancing current flowing through the light source module;
a plurality of voltage sensing circuits, each voltage sensing circuit connected to the corresponding transformer and resonance circuit, for sensing a voltage level of the signal provided to the light source module; and
a pulse width modulation (PWM) controller connected between the voltage sensing circuits and the power stage circuit, for controlling output thereof according to the sensed voltage level.

8. The driving device as claimed in claim 7, further comprising a DC power source for providing the DC power signal.

9. The driving device as claimed in claim 7, wherein each of the current balancing circuits comprises a common-mode choke having a first coil and a second coil, respectively connected between the transformer and resonance circuit and corresponding lamps of the light source module.

10. The driving device as claimed in claim 9, wherein each of the voltage sensing circuits comprising:
a first voltage divider component;
a second voltage divider component connected in series with the first voltage divider component;
a third voltage divider component; and
a fourth voltage divider component connected in series with the third voltage divider component;
wherein the first and second voltage divider components are connected between the first coil of the current balancing circuit and the ground, and third and fourth voltage divider components are connected between the current balancing circuit and the ground.

11. The driving device as claimed in claim 10, wherein the first, second, third, and fourth voltage divider components comprise capacitors.

12. The driving device as claimed in claim 7, wherein the current balancing circuit comprises a plurality of coils respectively connected between the transformer and resonance circuit and corresponding lamps of the light source module.

13. The driving device as claimed in claim 12, wherein each of the voltage sensing circuits comprises:
a first voltage divider component;
a second voltage divider component connected in series with the first voltage divider component;
a third voltage divider component; and
a fourth voltage divider component connected in series with the third voltage divider component;
wherein the first, second, third, and fourth voltage divider components are connected between the corresponding coil of the current balancing circuit and the ground.

14. The driving device as claimed in claim 13, wherein the first, second, third, and fourth voltage divider components comprise capacitors.

15. The driving device as claimed in claim 7, further comprising a feedback circuit connected between a low voltage terminal of the secondary winding of the transformer and the PWM controller, for providing a feedback signal of the current flowing through the light source modules.

16. A circuit assembly comprising:
a light source module comprising at least one lamp installable therein;
a power stage circuit for providing alternating current (AC) signals;
a transformer and resonance circuit electrically connectable with said power stage circuit so as to accept said AC signals from said power stage circuit and converting said AC signals to drive said at least one lamp of said light source module for illumination;
a current balancing circuit electrically connectable between said transformer and resonance circuit and said light source module so as to balance electrical currents flowing through said light source module;
a voltage sensing circuit electrically connectable between said current balancing circuit and said light source module in order for sensing voltage levels of said converted AC signals provided to said light source module; and
a controller electrically connectable between said voltage sensing circuit and said power stage circuit to control signal provision of said power stage circuit according to said sensed voltage levels of said converted AC signals from said voltage sensing circuit.
